(19) United States
(12) Patent Application Publication
(10) Pub. No.: US 2023/0001570 A1
(43) Pub. Date: Jan. 5, 2023

(54) MODULAR FRAME FOR AN INTELLIGENT ROBOT

(71) Applicant: X-Tend Robotics Inc., Middleburg, FL (US)

(72) Inventors: Harry FOX, Jerusalem (IL); David AZOULAY, Jerusalem (IL); Sergh SAPOJNIKOV, Ashkelon (IL); Andrew C. GORELICK, Ashkelon (IL)

(21) Appl. No.: 17/849,645

(22) Filed: Jun. 26, 2022

Related U.S. Application Data
(60) Provisional application No. 63/216,539, filed on Jun. 30, 2021.
(60) Provisional application No. 63/233,837, filed on Aug. 17, 2021.

(51) Int. Cl. B25J 9/08; B25J 9/00; B25J 9/16

(52) U.S. Cl. CPC B25J 9/08; B25J 9/0009; B25J 9/161

(57) ABSTRACT

A modular frame for an intelligent robot includes a base and one or more devices for performing specified functions. The base controls the actions and functions of the robot and contains a memory of operating instructions for a plurality of modules, each module performing unique functions. The base has a smart connector. The devices for performing specified functions have a smart connector which contains a unique code for that device or module and firmware for operation of the module. When a module is affixed on the modular frame, the smart connector of the module electronically communicates with the smart connector of the base, thereby providing the base with sufficient operating information to operate the intelligent robot.

### CROSS-REFERENCE TO RELATED APPLICATIONS

This application claims priority from U.S. provisional patent applications 63/216,539, filed Jun. 30, 2021, and 63/233,837, filed Aug. 17, 2021, both of which are incorporated herein by reference.

### FIELD OF THE INVENTION

This invention pertains to robotics, and, in particular, to a modular robot that allows the various functional modules to be interchanged and/or rearranged.

### BACKGROUND OF THE INVENTION

Robots are now ubiquitous and are used for a myriad of purposes in many different industries.

There are many current bafflers facing the service and personal robot industry. Among them are:

It takes an average of 3.5 years and $35 million to develop a mobile, autonomous service robot.

The cost-of-Service Robots makes them unaffordable for most enterprises. Service Robots are designed for a specific application and are not configurable. Robots can only function fully when connected to the Internet. Most robots are reactive, limiting their applicability.

Accordingly, there is a need in the industry for making robots affordable and accessible for all businesses and application; and, also, there is a need in the industry and field for a device or system that can efficiently and effectively allow interchangeability and/or relocation of the functional modules of the robot.

### SUMMARY OF THE INVENTION

To achieve these and other objects, the herein device facilitates interchangeability and/or relocation of the functional modules of the robot.

Therefore, to achieve these and other objects, the herein disclosed invention is a modular frame for an intelligent robot, comprising: a base controlling the actions and functions of the robot and containing a memory of operating instructions for a plurality of modules, each module performing unique functions, and the base having a smart connector; one or more devices or modules for performing specified functions and having a smart connector, the smart connector containing a unique code for that device or module and firmware for operation of the module; and wherein, when a module is affixed on said modular frame, the smart connector of the module electronically communicates with the smart connector of the base, thereby providing the base with sufficient operating information to operate the intelligent robot.

Currently, robots are typically developed from the ground up, one model at a time, for a specific deployment. For each new deployment, new hardware and software are developed. This methodology has proven to be costly, time consuming and inefficient. In order to meet the demand for the cost sensitive and widely diversified Social Robotic market, Applicant has created a proprietary technology, enabling redeployment typically 80% of the robot's core “4 pillars” architecture needed for the development of custom Social Robots for any need, in a fraction of the time and cost of conventionally designed robots.

The herein disclosed modular frame is designed to be flexible, modular, and scalable, without compromising on performance, efficiency and reliability. This “Lego” type system ensures that virtually limitless configurations can be built to satisfy customer deployment objectives by integrating the appropriate sensor packages and designing mission specific external forms, for a wide range of applications.

The herein disclosed modular robot is the next generation of a M-RAP proprietary Modular Robotics Architecture Platform, that will further reduce the time and cost of Service Robot Development. All M-Rap core and accessory modules have built in Intelligent connectors that contain the “DNA” of each hardware component, enabling the Robot “Brain” to automatically recognize all the hardware components used or added later and then automatically compile the necessary software/firmware, each to be able to manage and control each Robot. This enables virtually unlimited customization for any vertical market deployment. It allows open plug and play APIs and development kits to 3^{rd} party accessory manufacturers to develop and sell value added accessories that can be plugged into each Robot in the after-market.

The base includes a robot basic operating system and hardware code that controls and commands physical devices and modules affixed to the modular frame of the robot. In some embodiments, the base includes CPU, MCU and power supply boards, a robot operating system Command library, and an Artificial Intelligence engine. Included within the base or brain is a communications protocol. Means for autonomous movement may be included.

There is also provided a modular kit for generating an intelligent robot. The modular kit includes a plurality of selectable base modules, and a plurality of selectable functional modules. The base modules include a robot firmware including low-level hardware code that controls and commands at least the base modules, a robot operating system (OS) including a plurality of operating instructions for a plurality of functional modules, a data library that contains firmware, features and functions of the base modules and the functional modules, and at least one of a smart Lync hub and smart connector, the at least one of a smart Lync hub and smart connector capable of connecting to a plurality of smart connectors simultaneously. The plurality of selectable functional modules perform specified functions, each selectable functional module having a smart connector containing a unique code for the functional module and firmware for operation of the selectable functional module.

Moreover, in accordance with a preferred embodiment of the present invention, the plurality of base modules also include at least one of a smart firmware, a communications protocol, a CPU, an MCU, a power supply board, a robot operating system command library, an Artificial Intelligence engine, a memory, and a communication module.

Further, in accordance with a preferred embodiment of the present invention, the functional modules to operate in any assigned position within the intelligent robot and/or in assigned orientation.

Still further, in accordance with a preferred embodiment of the present invention, the functional modules to communicate with the base modules electronically via the smart connector.

Moreover, in accordance with a preferred embodiment of the present invention, the functional modules are at least one of a medication dispenser, a gripping arm, a torso element, a medical device or equipment, a sanitation device or equipment, a transportation device or equipment, a culinary device or equipment, an entertainment device or equipment, and a personal health and aid device.

Further, in accordance with a preferred embodiment of the present invention, the smart connector includes a unit to provide the base modules with sufficient operating information for the kit to operate as an intelligent robot.

Still further, in accordance with a preferred embodiment of the present invention, the smart connector includes at least one of a wireless communication unit and a wired connection.

Moreover, in accordance with a preferred embodiment of the present invention, the smart connector includes a unit to communicate at least one of attached module identification, attached module attachment method, attached module position, attached module prescribed functions, attached module purchased/prepaid optional functions, attached module associated design data, and attached module verification data.

Further, in accordance with a preferred embodiment of the present invention, the associated design data is at least one of a logo, a theme, and a design.

Finally, in accordance with a preferred embodiment of the present invention, the verification data is licensed, unlicensed, or pirated.

### BRIEF DESCRIPTION OF THE FIGURES

For a better understanding of the invention and to show how it may be carried into effect, reference will now be made, purely by way of example, to the accompanying Figures, wherewith it is stressed that the particulars shown are by way of example and for purposes of illustrative discussion of the preferred embodiments of the present invention only, and are presented in the cause of providing what is believed to be the most useful and readily understood description of the principles and conceptual aspects of the invention.

FIG. 1 is a diagram showing of the architecture of the modular robot.

FIG. 2 is a diagram showing the electrical connections of the components of the modular robot.

FIG. 3 is a view showing the skeletal frame of the modular robot.

FIG. 4 is a view showing different functional modules that may be added to the modular robot.

FIG. 5 is a flow chart, showing the process of how the invention works.

FIG. 6 is a diagram, illustrating how the modules may be connected.

FIGS. 7 and 8 are connection charts, showing how the modules are connected to the base module.

### DETAILED DESCRIPTION OF THE INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In a basic embodiment, the Invention constitutes a device facilitating interchangeability and/or relocation of the functional modules of the robot.

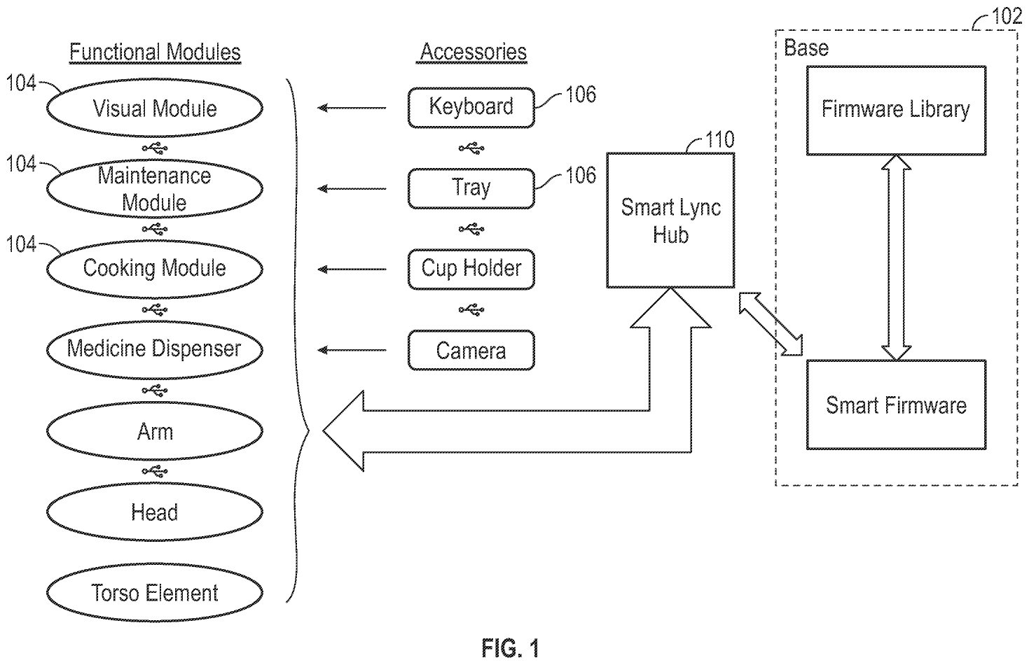

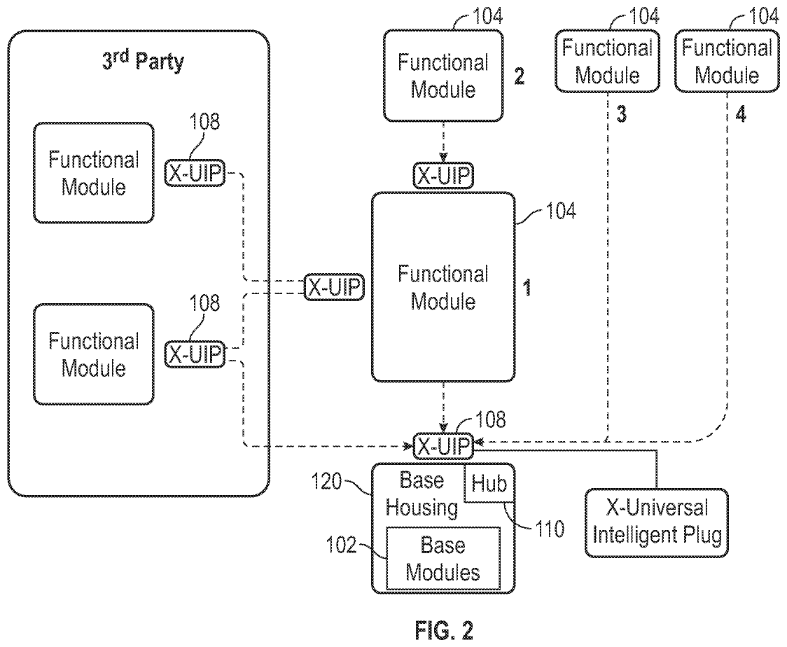

Reference is now made to FIGS. 1 and 2, which illustrate an embodiment of the present invention, having a modular kit or a frame 100 from which to generate an intelligent robot. FIG. 1 shows the basic architecture of the invention and FIG. 2 shows how the modules of kit 100 connect.

Kit 100 comprises base modules 102, a plurality of functional modules 104, a plurality of accessories 106 and a smart lync hub 110. Each base module 102 and each functional module 104 may comprise a smart connector 108 (shown as an X-UIP in FIG. 2) with which to connect to hub 110 which, in turn, may provide communications among base modules 102 and functional modules 104.

Base modules 102 may control the actions and functions of the generated robot and may contain a memory of operating instructions for functional modules 104, each of which performs unique functions.

Each smart connector 108 contains a unique code for its functional module 104 or base module 102 and firmware for operation of the module. When a module 102 or 104 may be affixed to smart hub 110, the smart connector 108 of the module electronically communicates with smart hub 1102, which, in turn, communicates with base modules 102, thereby providing the base with sufficient operating information to operate the intelligent robot.

Functional modules 104 may comprise, for example, arms, torso elements (upper, middle and lower), claws, a maintenance device, a cleaning device, a medical device, a cooking device, a personal aid device, a fitness device, a cabinet, a draw, a tray set, etc., some of which are shown in FIG. 1. Each of these modules and its associated accessories may be made in-house, or commissioned for personal company use exclusive by out-house, or third-party individuals or other companies (through licensing or other monetary or non-monetary transactions).

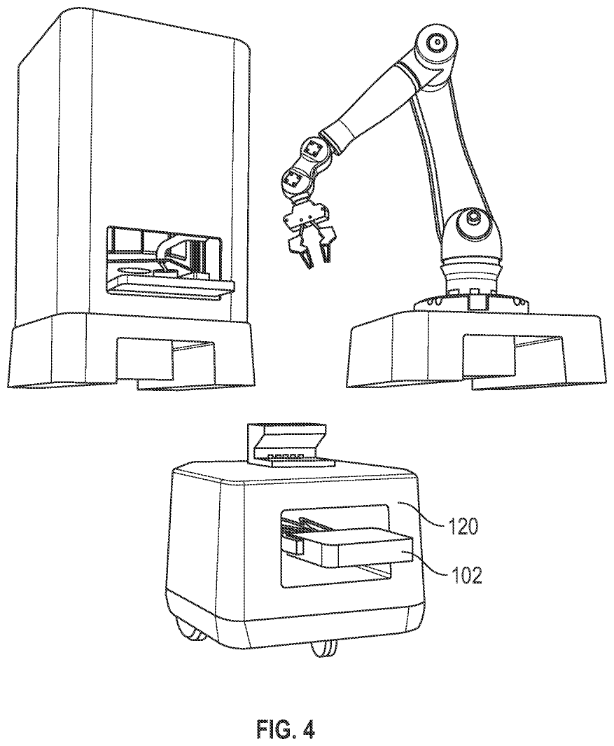

Accessories 106 may comprise a tray, a cup holder or a keyboard, that connect through proprietary or standard interfaces, and have no smart connector. In its preferred embodiment, base modules 102 may be individually connected or may be connected to each other and may be housed together in a base housing 120, thereby forming a base controlling the actions and functions of the robot. Base modules 102 may comprise all the components necessary to operate and control the robot. A typical base module 102 and base housing 120 is shown in FIG. 4.

Base modules 102 may include a robot basic operating system and hardware code that controls and commands physical devices. In some embodiments, base housing 120 may house base modules 102, CPU, MCU and power supply boards, a robot operating system command library, and an artificial intelligence engine. Accessories, such as wheels, a lidar unit, a keyboard, a display and USB connectors, may also be attached to base housing 120. It will be appreciated that any function, accessory and any functional module may be placed anywhere and in any orientation within the generated robot.

Base modules 102 may comprise a firmware library and a smart firmware, for controlling smart lync hub 110. Memory may be included therein, along with the CPU, MCUs, power supply, communication modules and all other electronics that are needed to operate the robot.

Base modules 102 may comprise a firmware library and a smart firmware, for operating smart lync hub 110. Memory may be included therein, along with the CPU, MCUs, power supply, communication modules and all other electronics that are needed to operate the robot.

According to the invention, the generated robot may operate offline or online as described in US provisional patent applications 63/304,621 and 63/310,120, commonly owned by Applicant. For online operation, one or more base modules 102 may comprise a suitable wireless communication unit. For example, it may be a Wi-Fi or cellular data unit. This may enable it to communicate over the internet or a local network or even through cellular telephone service to receive operational instructions.

More particularly, the intelligent robot may include human interface devices such as speakers, microphones and a touch screen, as needed. These may be part of any suitable functional module 104. In this manner, a person in close proximity to the robot can communicate with the base modules 102 to provide instructions on specific functions or operations for the robot to perform.

In this exemplary embodiment, base housing 120 may house one or more smart connectors 108 or smart hub 110, also known as a Smart Lync connector.

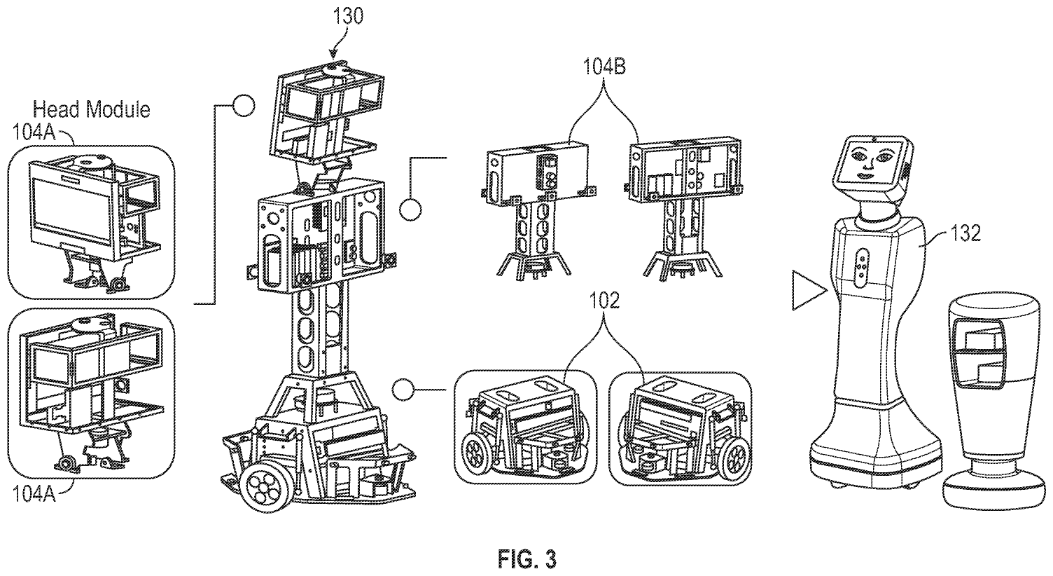

The exemplary embodiment of a skeletal frame of a basic robot is shown in FIG. 3. In this embodiment, modules may be connected together as ‘skeletal’ or ‘unfinished’ modules, which may be made of any suitable material, such as metal.

Thus, a user may select one of a plurality of head modules 104A and may attach it onto a selected one of torso modules 104B. The combination may be attached to a selected one of base modules 102, producing a skeletal frame 130.

Components may be secured together in conventional manner, as by screws, bolts etc. Spacing accessories may be placed between modules so as to place modules in the desired position.

Once assembled, an outer skin 132 may be applied for aesthetic purposes. The outer skin 132 may be made of any suitable material, such as plastic. It will be appreciated that in other embodiments, the robot may be constructed of modules that have an outer skin, and as such do not require a separate outer skin to be added.

The exemplary robot may have modules that are shaped into a head module, a torso module and a base module, as shown, but any number and configuration of modules may be possible according to the herein invention. It will be appreciated that modules may have shapes dependent on the positioning or function of a module, or to simulate a non-robot design such as an animal or a humanoid. Each module may perform any assigned function, in any assigned position, in any assigned orientation within the robot. This may be in contradistinction to standard robots wherein a functional module or accessory may be located in only one spot on the robot. In such a robot, to change its location or function may require an entirely new design of the robot, including reprogramming of the software and firmware.

When a functional module 104 is selected for the intelligent robot, it may include a smart connector.

Once that functional module is positioned and affixed to the robot, the smart connector may be placed in electronic communication with the smart connector or hub on base modules 102. This may allow the operational information for that functional module 104 to be provided to the base module 102, thereby allowing the base to control this functional module in concert with operation of the robot.

The electronic communication may be established in any known manner Wire or cables may run internally along the skeletal frame to connect the two smart connectors. In some embodiments, this electronic communication may also be done wirelessly, such as with Bluetooth or Near Field Communication (NFC).

FIG. 4 shows some possible modules that may be placed on the robot and a base unit with base housing 120 and base module 102 therein. For example, a medication dispenser or a gripping arm (shown in the top portion of the drawings). Other examples of possible modules and their associated accessories, for illustrative purposes only and not intended for limitation, may include: medical devices or equipment, sanitation devices or equipment, transportation devices or equipment, culinary devices or equipment, entertainment devices or equipment, personal health and aid devices or equipment, or any devices or equipment that may benefit from attachment to an intelligent robot.

Referring again to FIG. 1, there may be one or more smart Lync hubs or smart connectors in the base modules 102. Any number and type of functional modules 104 may be connected to the base module 102 or modules. Also shown are several different possible accessories, like trays and keyboards. Even modules created by third parties may be connected, as long as they include a smart connector with the relevant operational information about the functional module 104.

Another basic configuration may have base module 102 in the lowest positioned module. Head and torso modules are included with specified functionality. If desired, other modules and accessories may be attached.

The robot may have base modules and may have additional “functional” module(s). One base module may contain (as a single unit or collectively) the following elements:

the firmware of the robot, the major software of the robot including the Operating System (OS), and a “data library” (a library of all/most needed firmware/features/functions of all/most modules).

When the base modules 102 are assembled and the chosen functional modules are connected through the smart connectors 108, the robot may use the data obtained from the smart connectors to know some or all of the following:
What module is being attached,
How the module is being attached,
Where it is being attached,
Module position,
Module orientation,
What prescribed functions the module serves,
To what purchased/prepaid optional functions the module has access,
What design data, if any, is associated with the module (such as, for example, company logo of 1^{st}, 2^{nd}, 3^{rd} party developers or of the module or a customer design/logo/theme added to the module).
Verification data that the module is licensed and not pirated or unlicensed.

The smart connector 108 may communicate this data to the base module or modules 102.

In turn, it may obtain relevant information from the data library and respond appropriately to allow the firmware and operating system of the base module(s) to function properly with its associated functional module 104.

As mentioned hereinabove, there may be multiple choices of base and functional modules. Some modules may serve similar purposes to one another and some modules may serve different purposes to one another. In an exemplary embodiment of a humanoid shaped robot, functional modules may be shaped as: a head, a head extensions, a torso (which may break down to an upper torso, a mid-torso, and a lower torso), and a bottom unit which may house the base module(s). Each of these modules may have one design or many designs from which to choose. Modules may also have different orientations from which to select (like the head may be placed landscape or portrait, or the torso with connector on left vs right or front vs back, etc.).

The smart connector may be coupled with, or may be separate from, a physical connector to hold the modules together. In some embodiments, the smart connector may be coupled with, or may be separate, from a power connector to give power to the modules (when power to a module is applicable). As mentioned hereinabove, the smart connector may store digital data. This digital data may be transferred through either:

wireless means like Near Field Communication (NFC), Bluetooth, or any known or proprietary wireless communication standard known and used, or wired means such as a proprietary plug, or a universal plug known or used (example: USB).

When purchasing a modular robot, a purchaser may need to purchase a specified robot, or may need to commission a robot, or the manufacturer may contact a company or government body to get commissioned for a robot. Then, the required robot may be created which includes selection of modules and features that fit the specified needs/wants/desires/budgets. This robot may be built like a Lego® creation, with the specified/required functions and features. The chosen robot may be ready and functioning in a short time frame, compared to current practices and technology.

Examples of a short time frame may be within a few days, within a few hours, and within a few minutes. Another time and cost saving measure will be in the manufacture of the intelligent robot. Not having to build and develop each robot as a whole, but rather only the individual modules themselves, may reduce manufacturing time and cost. It will also allow the dispersal of the production of the robot as a ‘module A’ may be manufactured in a ‘facility X’ in ‘country J’ while a ‘module B’ may be manufactured in a ‘facility Y’ in ‘country I’ contemporaneously.

The technical execution may be done in many ways known in the industry. According to the invention, the major point is that, upon connecting a functional module to base modules, either directly or indirectly, data stored on the functional module may be sent to the base module with the information needed to properly operate the functional module. Thereafter, the base module may use this information and may self-configure to operate properly. This allows for a customizable plug and play robot which may be built fast.

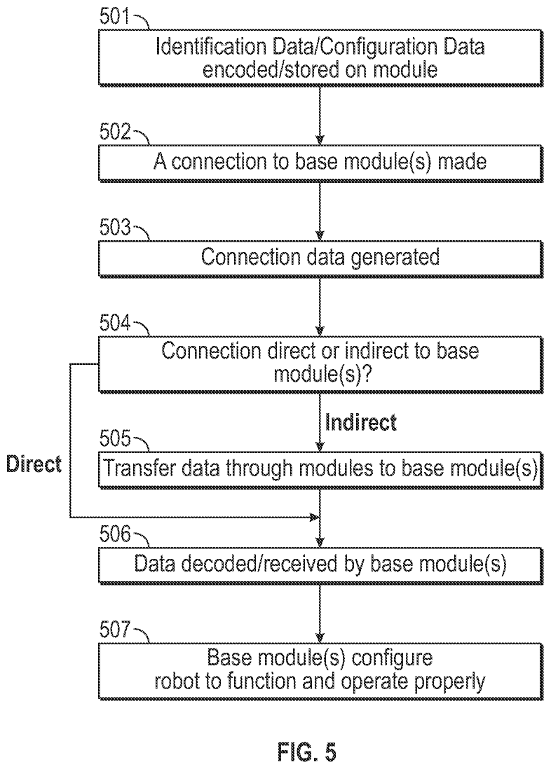

Reference is now made to the Flow Chart in FIG. 5.

The following is given as a general example of data flow during the assembly and initiation phase of robot production, and is provided for illustrative purposes only and not intended for limitation.

Step 501: The data may be preloaded onto the functional module 104, for example, onto a chip or part of a chip, a Solid-State Drive (SSD), Hard-Disk Drive (HDD), a QR code, Near-Field Communication (NFC) chip, bar code, etc. As may be appreciated, this process may be preferably done when the module is created, so it may be effected some time before the module is actually mounted on the robot. This data may be raw or configured and encoded. The data itself may be stored in many ways standard in the art examples of which are:
A [binary, for example] code for each piece of information where a number represents a specific predefined component. For example, there may exist 27 different modules and each one has a unique identifying number (0000,0001, 0010,0011 etc.). Another [binary] code may represent a specific predefined function. For example, there may exist 58 different functions and each one has a unique identifying number (0000,0001, 0010,0011 etc.). and so on and so forth.
A [binary, for example] code for each piece of information where a number represents a specific predefined component or function when segmented. For example, there may exist 127 different modules and each one has a unique identifying number (1001-0010-1111-0100) where the first set of digits may represent a unique identifier to a set of information like manufacturer, component number, component function, version number, year of production, warranty information, etc.
A larger set of code that may contain detailed data on the components and functions that does not require predefined numbers representing a specific component or function.
A set of data that, knowing the data library, holds information on where in the data library the data may be located that may be important to the functional use of the module and the modules component specifics Think of this embodiment like a pointer in C programming (A pointer may be a variable whose value may be the address of another variable, i.e., direct address of the memory location.). As in a set of data that represents a memory address or placement in data library to look up for the associated module.

Step 502: A connection is made. There may be a physical connection (which may be magnetic, a clip, screws, holstered, jointed, a snap-in-place, any means of physically connecting the two modules etc.) and an electrical connection (which may be plugging in wires (like USBs), wireless, Bluetooth, a placement in close proximity for NFC signals to be readable, a QR code to be scanned, a connection of two metallic points forming a continuous wire)

Step 503: In the embodiment where the smart connector, or smart link, 108 requires connection data (data on how and where the functional module may be being attached (see below) or any other data needed here),
What is being attached, (sometimes known beforehand)
How it is being attached, (option: may be known beforehand and worked into code or be generated upon connection)
Where it is being attached to, (option: may be known beforehand and worked into code or be generated upon connection)
What prescribed functions the module serves, (generally known beforehand)
What purchased/prepaid optional functions the module has access to, (generally known beforehand)
What design data, if any, is associated with the module (company logo of 1^{st}, 2^{nd}, 3^{rd} party developers or a customer design/logo/theme added to the module) (sometimes known beforehand).
Verification data that the module is licensed and not pirated or unlicensed (generally known/established beforehand)

The data may be generated in this step. Note that in other embodiments, this data may either be absent or generated beforehand once the configuration instructions are given, manually or digitally added to the modules, and input into step 501. In this embodiment of generating the connection data, the connection data may be done in a few different ways. For example, a connection list, or the base module(s) having designated ports representing specific placements on the robot.

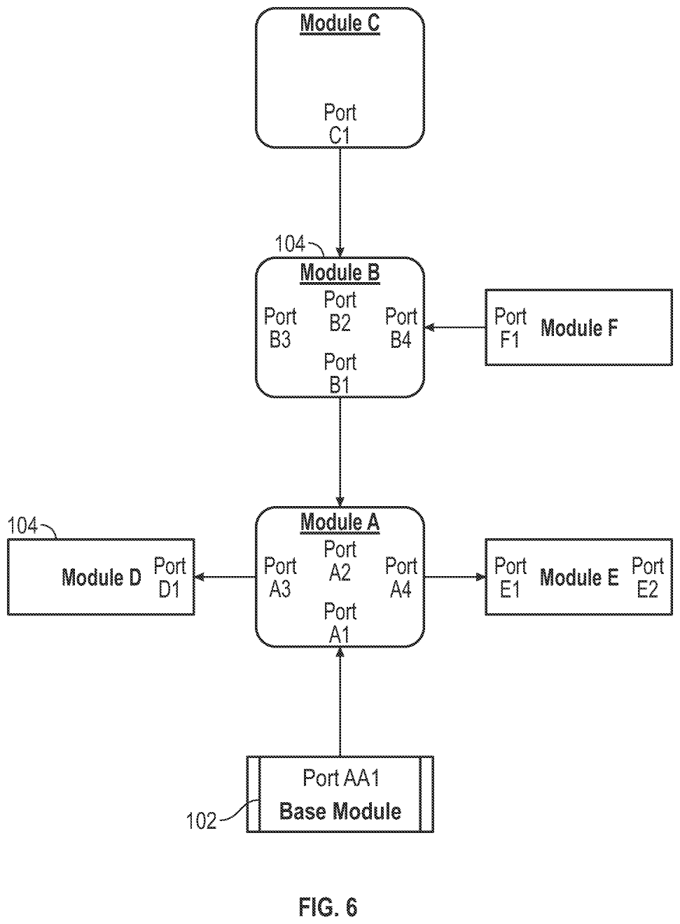

In the example of the connection list, an example execution is as follows. The option to generate the information on connection may be done by each port of the smart connector having a unique address in the robot. If a module is connected from a port to a port this information may be stored. This may be a very simple way to generate the information and as shown in FIG. 6.

With the connection list we generate the information on how and where each module may be connected for the smart link (This example has a single base module 102 for the sake of clarity, but broader examples exist).

For example, as shown in FIG. 6,

### Connection List:

Module A Path: A1→AA1
Module B Path: B1→A2→A1→AA1
Module C Path: C1→B2→B1→A2→A1→AA1
Module D Path: D1→A3→A1→AA1
Module E Path: E1→A4→A1→AA1
Module F Path: F1→B4→B1→A2→A1→AA1

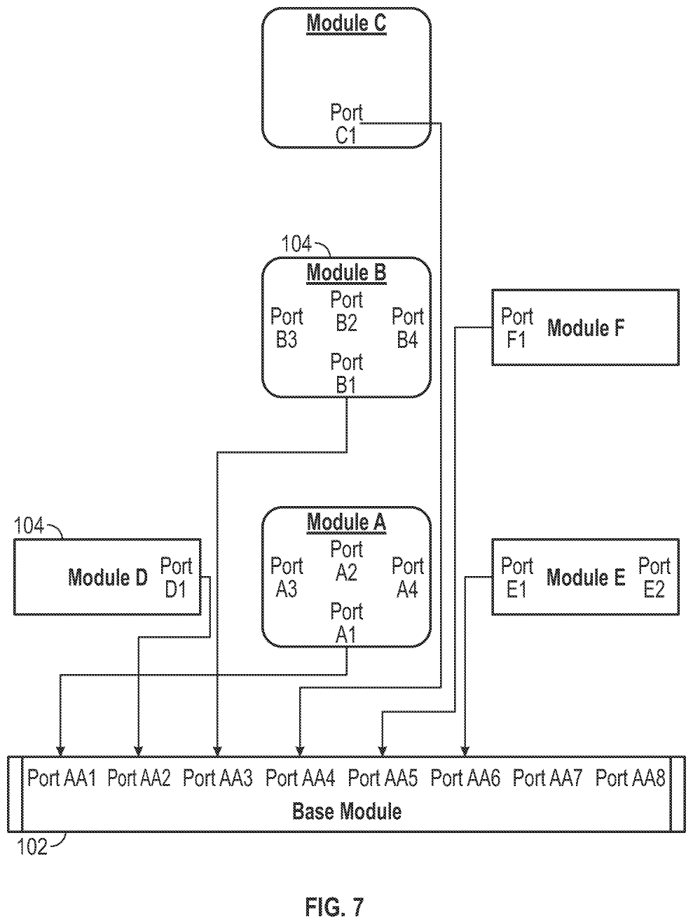

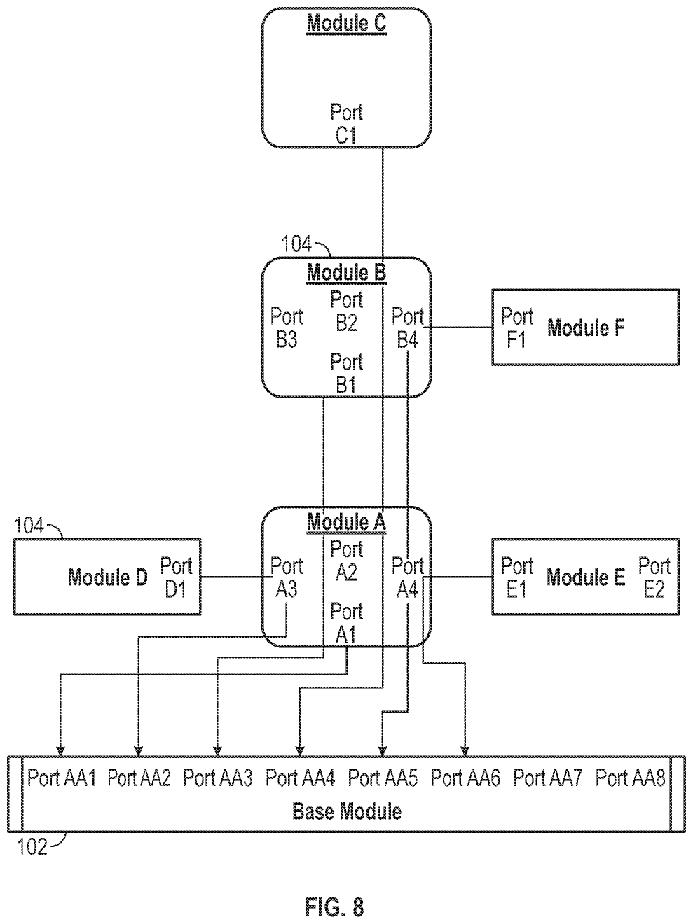

In the example of the designated ports an example execution may be as follows and reference is made to FIGS. 7 and 8.

Designated Ports: The option to generate the information on connection may be done by each port of the base module representing a specific placement. Thus, when a connection is made into the base module(s), it may be immediately known how it is being connected. This is shown in FIGS. 7 and 8, where FIG. 7 may represent an electrical connection separate from the physical connection (for example, running wires or wireless) directly into the port and where FIG. 8 may represent an electrical connection with the physical connection (for example, the wires run through intermediary modules or are connected through dumb ports (ports that simply extend the wire through without any intelligence)). (This example has a single base module 102 for the sake of clarity, but broader examples exist)

Step 504: A functional module 104 may either be directly connected to the base module(s) 102 or indirectly connected. In the case of designated ports, this may not likely be an issue as all connections are to the base module(s) are direct in some manner

Step 505: In the case of the connection list, a robot may have multiple indirectly connected modules, and each module may have multiple ports. There may be indirect connections and data internally from module port to module port will have to be transferred until it reaches the base module(s) 102. This may be done in a multitude of ways known in the industry by any wired or wireless means. As an example, this data may be held like a linked list (linear/non-linear linked data structure) in C programming (A Linked List is a very commonly used linear data structure which comprises of group of nodes in a sequence. Each node holds its own data and the address of the next node hence forming a chain like structure). This may be an extremely simple and non-data intensive way of storing connection data.

Step 506: The data may eventually be received by the base module(s) 102; and, if it is encoded, it may be decoded (based on the method of encoding) in this step to executable data. Note that encoding and decoding here may have broad terms. Encoding here may be as simple as the data being stored in step 501 and decoding may be the interpretation of that data into useable information.

Step 507: Once the data is executable, the base module 102 may process the data and may configure the robot by looking up from a data library (by an internal means for example downloaded data on an SSD or HHD or similar) or an external means (for example external drive plugged in or by the internet Wi-Fi, the cloud, ethernet plug). The base module(s) 102 may mark the important data and may additionally create/store a subset of the data library that the robot requires for quick look-up or access to operate the robot based on the ID/config/connection data.

Step 508: (This step is not shown in the flow chart of FIG. 5) In the case where the module comprises verification data, the base module(s) 102 may verify that the module is authorized or not unauthorized, unlicensed, or pirated. After this, the robot may be permitted to function. Note that this step may take place during step 506, after step 506 and before step 507, during step 507, and after step 507 without loss in function.

It will be appreciated that smart connectors and smart hubs may play a role in non and post-initialization features and operation. The smart connector may further comprise a smart connector chip that holds the information discussed in step 501. The initial specification details are similar to those in the initialization of the smart connector, as described hereinabove, but here we will add post initialization features for long term usability and example uses.

The smart connector chip may be used to, for example, aid in the data transfer between functional modules, initiate connection of functional modules, verify the authenticity of functional modules, verify the authenticity of functional module's functions and features, or any other data listed in the spec.

In the example of the smart connector chip comprising verification data, the chip may further be used to verify on a periodic basis that the robot or functional module or functional module feature is licensed, proper, or paid for. This may be done by requiring an internet access at the start or end of a period to check that the robot is licensed, proper, or paid for. Examples of periods may include a day, a week, a month, a year, or any appropriate time interval. This may be similar to how an online subscription is operated to an offline product. The function may operate normally offline, but at certain periods requires the user to connect to the internet and verify that the subscription is still active, so the user cannot pay for a single month of a subscription and keep it indefinitely.

In addition, the smart connector chip may provide diagnostics data for repair or development personnel, such as power usage, data usage, frequency of use, times of highest use volumes. The chips may also feature indicator lights for maintenance, similar to a car dashboard, providing signals for data connection errors, low power transfer, and other diagnostic issues. For example, if there is less than a threshold amount of power passing through the connector, a light on the chip will blink indicating a possible connection error. Similarly, if data signals are not being passing through the connector properly (I.e., somehow the signal may be disrupted or distorted), a light may blink

In preferred embodiments, means for autonomous movement, as is known in the industry, may be included. This modular platform for a robot may be a 3 layer system composed of hardware, software and artificial intelligence (AI).

The hardware layer may comprise the skeletal system of the robot and firmware, and the real time operating system (RTOS) which may be the low-level hardware code that controls and commands the physical devices.

The software (SW) platform may comprise the robot operating platform s (ROPS). This may be the robot basic operating system and in a preferred embodiment it may be a proprietary operating system based on open-source ROS framework. There may be also a Brain and Behavior system (B&B) that acts as a “bridge” between the RTOS and ROPS, and directly connects to the ACB component. In the preferred embodiment the B&B may be a proprietary intelligent system to control and command the physical robot devices. AI includes the ACB system.

An aspect of the invention is hardware modularity. There are a plurality of modules for performing operations of the robot, and these modules may be interchangeable and removable.

In order to meet the demand for the cost sensitive and widely diversified Social Robotic market, Applicant has created a proprietary technology, enabling redeployment typically 80% of the ROP's base “4 pillars” architecture needed for the development of custom Social Robots for any need, in a fraction of the time and cost of conventionally designed robots.

Pillar 1 is the Hardware architecture. This includes a configurable proprietary CPU, MCU and power supply boards and a ROS Command library.

Next is the physical form—a modular Interchangeable chassis.

The third pillar is an adaptable AI [artificial intelligence] engine.

Software is the 4^{th} pillar—customizable generic apps for Android, IOS, Windows and MAC OS that may remotely control all the Robot functions.

Depending on the robot's functional and deployment requirements, as the Central Processing Unit, the platform may support multiple CPU packages, ranging from a Raspberry Pi Compute Module3 for more basic single task applications, to the latest state of the art Nvidia Jetson Nano or the Nvidia Jetson Xavier NXAI supercomputer CPU modules to provide advanced Dynamic Neural Network (DNN) integrations.

This modular robot may support a wide range of MCUs with different performance and features from major manufactories, including, but not limited to, Microchip Atmel 8-bit AVR RISC-based microcontrollers, NXP ARM Cortex 32-bit Microcontrollers, Cypress 32-bit Arm Cortex Cortex-MO+PsoC.

The system may support all currently available commercial motors. Among the Protocols supported are: I2C, SPI, RS232, RS485, CanBus, TCP/IP, 1-wire. Modules for other protocols may be easily integrated.

Such a modular architecture may be engineered to be fully scalable, which may enable any Service Robot to be fully upgradable, thereby eliminating obsolescence.

It currently supports:
Multiple Central Processing Units that may be utilized as different parts of the platform or as one cluster computer to multiply the performance of the system.
Modular Power Supply Unit provides virtually unlimited power channels.
An unlimited number of different types of drivers.

Different software packages, developed by Applicant or 3rd-parties, may be integrated to expand the capabilities of any Service Robot. In additional to in-house developed modules for Natural Language processing, image processing, robot navigation packages, and others, this modular platform may support a plurality of different 3^{rd} party online and offline services, sensors, switches, devices, etc., that may be integrated with almost any major AI platforms (Google, Amazon, IBM, Microsoft, Apple, and many others).

Robots use many different process or applications running in a multi-threaded process. This may require the development of multiple process “applications per each sensor\function and to synchronize all the “tasks” without running into the conflict, which may require a great deal of CPU processing and memory management.

The base module 102 may be monitoring and running all processes all the time. AI then may decide what “Behavior” may be required, based on the sensory data it receives as a single “Task”. Each behavior may store the correct set of steps needed to be executed by the system, running completely independent and simultaneously monitored by the base modules. This architecture may be significantly more efficient, thereby enabling the Robot to dynamically support multiple behaviors and to adapt to new behaviors.

This architecture may provide the flexibility to write “Behaviors”—high level programing (may be done by a drag and drop method) instead of low-level code with full access to the low-level code when needed. The writing of a new behavior may be very simple and fast. Teaching this method may be relatively easy compared to traditional methods, which may enable use of open-source APIs that may enable any 3^{rd} party to define and execute custom behaviors.

The base module(s) 102 may be constructed of 3 different layers: An Environment Sensing layer, a Behaviors, and an Adaptive Cognitive Behavior layer. Generally, the first layer in the base module(s) 102 may be the ability to sense the environment in which the Robot is operating. This objective may be achieved by using a variety of environmental sensors:
Microphone array—for Command & Speech recognition;
12 MP camera & 3D Camera—for Face & Object Recognition, as well as other image and video processing needs;
Emergency sensors such as Smoke and Gas detectors; and/or
Lidar, Cliff, Infra-red sensors for navigation and collision avoidance abilities.
   Each sensor may be upgraded for the specific customer's needs.

The second layer in the base module(s) 102 may be the ability to define the different behaviors the robot performs. Behaviors are the way we simplify every task needed from one system to a set of state machines type commands (based on FlexBE2). Every behavior may use any of the available sensors to complete a basic task the robot may perform. Each state in the state machine may consist of a node—which may be essentially a thread that runs a specific compiled program/script written in any language the OS supports, such as C++, Python, and Java, to implement the different nodes.

According to the invention, the third layer in the base module(s) 102 may use Machine Learning and Deep Learning algorithms to better understand the robot's surroundings and assist the operator with its work. There may be sensing capabilities. Deep Learning algorithms for object recognition and face recognition are already implemented on many different devices.

Object recognition—the already mature YOLOv43/Faster R-CNN4 and tested algorithms may be in the herein disclosed modular robot. Even though both algorithms are similar in their basis—using anchor box-based network structure and bounding box regression—Faster R-CNN usually fails on real-time detection, while YOLO has a problem of detecting smaller objects. The herein modular robot may detect 50 different objects with high confidence, these objects may be daily essentials for a resident.

For face recognition—the herein modular robot may use DLIB library, which extract a 128 features vector, each point represents a point of interest on the subject's face. Using K-NN, it calculates the resemblance of a new face that the robot sees, to the ones it already knows. HOG or Resnet models may be used for the feature extraction process—the main difference would be the number of features to be extracted.

Fall detection—the herein modular robot detects a fall using built in sensors—mainly cameras.

It will be evident to those skilled in the art that the invention is not limited to the details of the foregoing illustrative embodiments and that the present invention may be embodied in other specific forms without departing from the spirit or essential attributes thereof. The present embodiments are therefore to be considered in all respects as illustrative and not restrictive, the scope of the invention being indicated by the appended claims rather than by the foregoing description, and all changes which come within the meaning and range of equivalency of the claims are therefore intended to be embraced therein.

1. A modular frame for an intelligent robot, comprising:
A base controlling the actions and functions of said robot and containing a memory of operating instructions for a plurality of modules, each module performing unique functions, and said base having a smart connector;
One or more devices or modules for performing specified functions and having a smart connector, said smart connector containing a unique code for said device or module and firmware for operation of said module; and
Wherein when a module is affixed on said modular frame, said smart connector of said module electronically communicates with said smart connector of said base, thereby providing said base with sufficient operating information to operate said intelligent robot.

2. A modular frame according to claim 1, wherein said base including a robot basic operating system and hardware code that controls and commands physical devices and modules affixed to said modular frame of said robot.

3. A modular frame according to claim 1, wherein said base including CPU, MCU and power supply boards, a robot operating system Command library, and an Artificial Intelligence engine.

4. A modular frame according to claim 1, wherein said base further comprising a communications protocol.

5. A modular frame according to claim 1, further comprising means for autonomous movement.

6.-17. (canceled)
